(19) United States
(12) Patent Application Publication
(10) Pub. No.: US 2002/0174932 A1
(43) Pub. Date: Nov. 28, 2002

(54) Safety control for mixing and dispensing wall board compound

(76) Inventor: Daniel Dea Dillinger, Parsons, KS (US)

Correspondence Address: James E. Bradley, BRACEWELL & PATTERSON, LLP, P.O. Box 61389, Houston, TX, 77208-1389, US

(21) Appl. No.: 10/190,200

(22) Filed: Jul. 5, 2002

Related U.S. Application Data
(63) Continuation-in-part of application No. 09/760,225, filed on Jan. 12, 2001.

(51) Int. Cl. B44C 7/04

(52) U.S. Cl. 156/71; 156/577

(57) ABSTRACT

A dispensing system for dispensing wall board compound has a tank on wheels. A helical mixing blade is located in the tank. The tank has an open top and a lid. A sensor detects when the lid is open. The sensor is connected to a controller which in turn controls the motor that rotates the mixing blade. A primary mixing switch will cause the motor to rotate the mixing blade unless the sensor detects that the top is open. A pair of override switches are available for overriding the sensor and causing the motor to rotate the blade even though the lid is open. Both override switches must be physically held in the on position for the mixing motor to remain on. The override switches are spaced apart so that two hands are required to hold them in the on position. This allows the user to observe the mixing while the lid is open.

### CROSS-REFERENCE TO RELATED APPLICATION

This application is a continuation-in-part of application of Ser. No. 09/760,225, filed Jan. 12, 2001.

### BACKGROUND OF THE INVENTION

1. Technical Field

This invention relates in general to dispensers for applying wall board compound to walls, in particular to a system having a mixing tank with safety switches for allowing the tank lid to remain open while mixing the compound.

2. Description of the Prior Art

Wallboard or drywall has become the dominant material in the production of interior building partitions. Interior building partitions typically comprise a studwall of vertical support members or studs that are spaced apart from each other in a parallel arrangement. The studs are used to support preformed panels or wallboards that are usually attached to the studwall with fasteners. A joint exists between adjacent ones of the abutted wallboards.

In order to provide a continuous flat surface appearance to the wall, it is necessary to apply a finish to the joint between the adjacent panels. Finishing typically requires the build-up of multiple layers of a mastic material or joint compound. The compound is a paste-like substance that is formed by mixing a powdery compound with water. The blending of the joint compound into the panel surface forms the desired flat and contiguous wall surface. The build-up of compound in the joint area or “floating” comprises the application of a first layer of compound and the embedding of a wallboard tape such as paper or fiberglass tape in the first layer. Finally, one or two more layers of compound are applied on top of the first layer/tape to complete the joint. The finishing of the joints is a time consuming and labor intensive process.

It is convenient to use a dispenser for the compound which may or may not include means for supporting a roll of tape. Combination compound and tape devices guide the tape through the compound and dispense it from the dispenser at the desired length with the tape coated in the compound. A number of devices have been proposed in attempts to more efficiently and effectively dispense compound during the process. Some devices are pressurized to dispense the compound, while others require traditional manual application.

### SUMMARY OF THE INVENTION

The system of this invention has a tank for mixing and holding the compound to be dispensed. The tank is portable, being mounted on wheels. A rotatable mixing member is mounted inside the tank. A controller controls a motor for rotating the mixing member.

The tank has a lid, which is normally closed while the mixing member is rotating. While undergoing premixing, the operator may wish to inspect the compound from time to time to determine whether or not it has achieved the desired consistency. Water is blended with the compound and the mixing member is rotated until the desired consistency is achieved.

For safety, a sensor detects when the lid is open and signals a controller to stop the motor from rotating the mixing member. In order to allow the operator to observe at least part of the mixing process while the mixing member rotates, a pair of override switches are connected between the controller and the motor. The override switches are in a normally off position and require continuous manual pressure to both switches by the operator in order to remain in an on position. The switches are spaced apart, preferably on opposite sides of the controller, so that the operator must utilize both hands to actuate the override switches. This reduces the chance for the operator to accidentally place a hand in the mixing chamber while the mixing member is rotating.

### BRIEF DESCRIPTION OF THE DRAWINGS

FIG. 1 is a schematic representation of a system constructed in accordance with this invention.

FIG. 2 is a perspective view of the apparatus of FIG. 1.

### DETAILED DESCRIPTION OF THE INVENTION

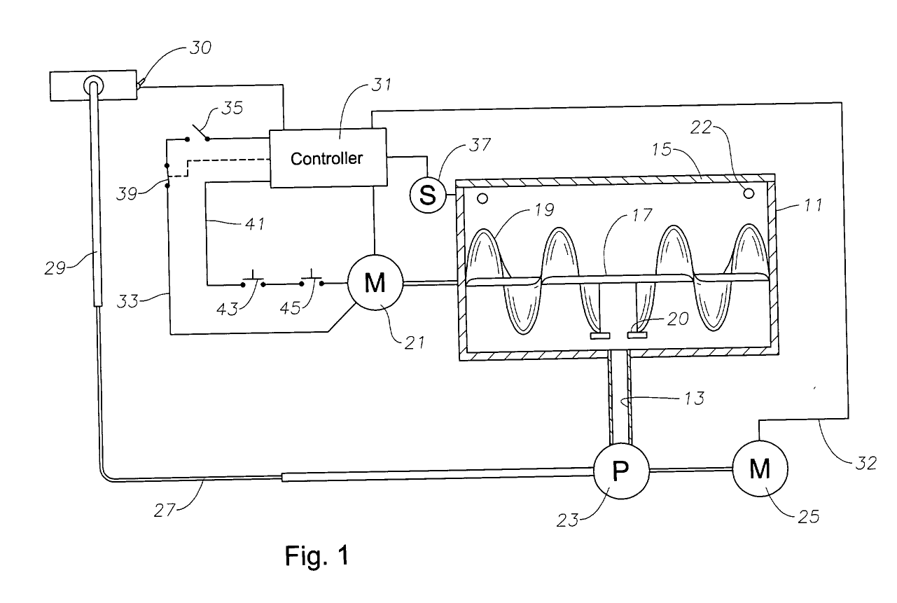

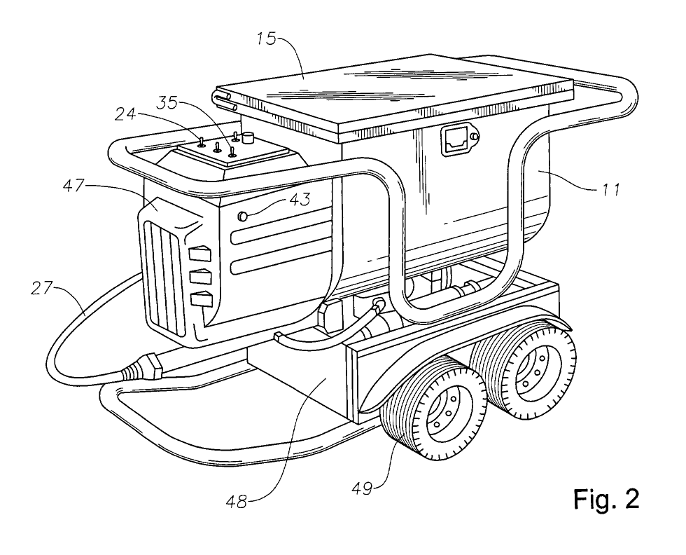

Referring to FIG. 1, tank 11 is preferably rectangular, as shown in FIG. 2, having two ends and two sides. An outlet 13 extends from the bottom, outlet 13 being centrally located in the preferred embodiment. The top is open but has a lid 15 that is secured by a hinge. Lid 15 may be moved freely between open and closed positions.

A mixing member is located inside tank 11. The mixing member is rotated by a drive shaft 17 that extends from one end to the other of tank 11 and comprises one or more augers or blades 19 that are mounted to shaft 17 for rotating in unison. In the preferred embodiment, there are two blades 19, each being helical but extending in opposite directions so that one end 20 of each blade 19 is located in a central area above outlet 13. When shaft 17 rotates in a forward direction, blades 19 stir and push compound toward the central area and outlet 13. When rotated in the reverse direction, blades 19 stir and convey compound away from outlet 13 toward the opposite ends. Alternatively, outlet 13 could be located adjacent one end of tank 11 and a single helical blade 19 employed. In that embodiment, the blade would push compound toward the outlet when rotated in a forward direction and away from the outlet when rotated in a reverse direction. A motor 21 is mounted outside of tank 11 for rotating shaft 17.

One or more water jets 22 are optionally mounted to one of the sides of tank 11 for spraying water into the interior of tank 11. The water for water jets 22 may be delivered by an onboard water tank or by a hose connected to a water supply. A solenoid valve (not shown) is incorporated with each water jet 22 for opening and closing water jets 22. A switch 24 (FIG. 2) on the unit controls the solenoid valves. Switch 24 requires continuous manual pressure to keep the valves in an on position.

A pressure source or pump 23 is mounted to outlet 13 for pumping compound flowing out outlet 13. Pump 23 is preferably a progressive cavity pump driven by an electrical motor 25. Pump 23 pumps compound through a hose 27 that extends to a remote applicator 29. Applicator 29 is held by the user for applying compound to a wall surface. A switch 30 is mounted on applicator 29 for turning pump motor 25 on and off. Applicator 29 may optionally also dispense tape simultaneously with the compound.

A controller 31 controls the two motors 21, 25. Controller 31 has a line 33 that leads from a power source to mixer motor 21 for supplying power to rotate blades 19. A primary switch 35 is schematically shown located in line 33. When moved to the on position, switch 35 will cause electrical power to be supplied to motor 21. Switch 35 is shown schematically and is preferably a relay switch controlled by a manually operable switch (not shown) on controller 31. Controller 31 also controls pump motor 25 via a line 32.

For safety purposes, a sensor 37 is mounted to tank 11 for sensing when lid 15 is open. Sensor 37 is preferably a magnetic reed switch that senses when lid 15 is closed and when open. Sensor 37 is connected with controller 31 such that when lid 15 is open, controller 31 supplies power to a switch or relay 39 to cause it to open. Switch 39 is located in line 33 in series with primary switch 35, thus when open, prevents any voltage from being supplied to mixer motor 21 even if primary switch 35 is closed.

There are times when it is useful to observe the contents being mixed to determine whether the proper viscosity is being achieved. In order for the operator to do this, a pair of override switches 43, 45 are connected in a line 41 leading from controller 31 to mixer motor 21. Override switches 43, 45 are of a type that are normally open, each being biased by a spring to an open position. Both switches 43, 45 must be moved manually to the on position and continuously held in that position in order to remain in the on position. Although schematically shown as to be directly connected between motor 21 and controller 31, it should be clear that switches 43, 45 preferably control relays located in line 41.

Override switches 43, 45 are physically spaced apart from each other a sufficient distance to prevent a user from depressing both switches with one hand, thus they will be at least about nine inches apart from each other. In the preferred embodiment, switch 43 is mounted on one side of a housing 47 that encloses controller 31, as shown in FIG. 2. Switch 45, though not shown in FIG. 2, is on the opposite side of housing 47. Consequently, the user must place one hand on one side of controller housing 47 and the other hand on the other side of controller housing 47. Also, preferably one of the override switches 43, 45 is within a short distance, such as less than seven inches from switch 24, which controls the opening and closing of water jets 22. This allows a user to depress both switch 24 and one of the override switches 43, 45 simultaneously with one hand. A thumb could be used to depress switch 24 and one of the fingers of that hand could depress one of the override switches 43, 45.

Referring still to FIG. 2, tank 11 and housing 47 are preferably mounted together on a frame 48 that is mounted on wheels 49 that allow the unit to be portable. In operation, the operator will place compound in the interior of tank 11 with lid 15 open. The operator adds water, which may be poured directly into tank 11 or delivered by jets 22. The operator then closes lid 15 and places primary mixing switch 35 in the on position. This causes motor 21 to rotate blades 19. The water and compound will mix due to the action of blade 19. The operator can add water via jets 22 while lid 15 is closed. However, it may be difficult to determine the proper consistency without looking at the mixture. The operator can raise lid 15, which automatically causes motor 21 to cease operating even though primary switch 35 is still in the on position. This occurs because sensor 37 will cause controller 31 to open switch 39. Unless override switches 43, 45 are depressed, no power will be supplied to motor 21 when switch 39 is open. The operator can view the contents and simply close lid 15 to allow mixing to continue.

Alternatively, if the operator wishes to observe the mixing, he can do so by manually depressing both override switches 43, 45. He will hold one switch 43 with one hand and the other override switch 45 with the other hand. This allows power to be supplied to motor 21. If the operator removes either hand from switch 43, 45, the circuit is broken because switches 43 and 45 are in series. During the override operation described above, primary mixing switch 35 may remain in the on or off position. The operator can add water at the same time as the override switches 43, 45 are being depressed by depressing switch 24.

Once a desired consistency has been achieved, the operator closes lid 15 and begins dispensing the compound by pressing switch 30 on applicator 29 and moving applicator 29 along a surface. When switch 30 is in the on position, controller 31 supplies power to mixing motor 21 to cause blades 19 to rotate in a forward direction, forcing compound toward outlet 13. Power is also supplied to pump motor 25 via pump line 32. Motor 25 rotates pump 23, which pumps compound from outlet 13 through hose 27 and applicator 29. When switch 30 is moved to the off position, motor 25 ceases operating.

Controller 31 has two modes of operation for applicator switch 30. In on-demand mode of operation, depressing switch 30 causes pump motor 25 to rotate only while switch 30 is depressed. In another mode of operation, the same switch 30 will cause motor 25 to rotate continuously once depressed even though the manual pressure on switch 30 is released. In the other mode, pressing switch 30 a second time stops motor 25. When switch 30 is depressed a third time, motor 35 again begins to drive pump 23. Thus pressing and releasing switch 30 while operating in the other mode changes the condition of motor 25 from on to off, or from off to on.

Controller 31 also has two modes of operation for controlling mixer motor 21 while compound is being dispensed. Motor 21 rotates blades 19 in a forward direction to urge compound toward outlet 13 any time that pump motor 25 is driving pump 23. In a continuous mode of operation, mixer motor 21 will continuously rotate blades 19 whether or not pump motor 25 is operating. In the intermittent mode, motor 21 rotates blade 19 only when pump motor 25 is operating.

The invention has significant advantages. The safety system prevents an operator from freely allowing the mixing blade to rotate while the lid is open. It still, however, allows an override so long as the operator performs the override feature safely, which is by depressing two spaced-apart buttons.

While the invention has been shown in only one of its forms, it should be apparent to those skilled in the art that it is not so limited but is susceptible to various changes without departing from the scope of the invention.

I claim:

1. An apparatus for dispensing wall compound, comprising:
a tank having an outlet;
a hose in communication with the outlet;
an applicator secured to the hose;
a pressure source for delivering compound from the outlet of the tank through the hose to the applicator;
a mixing member mounted rotatably in the tank for mixing compound;
a motor operatively connected to the mixing member for rotating the mixing member;
a lid on an upper end of the tank, the lid being movable from a closed position to an open position for access to the interior of the tank;
a sensor that detects when the lid is in the open position;
a controller adapted to be connected to a power source, the controller having a primary mixing switch that controls the motor and is operatively connected with the sensor for preventing operation of the motor if the sensor senses that the lid is in the open position; and
a pair of override switches mounted on the apparatus, each of the override switches being biased to an off position and requiring manual force to remain in an on position, the override switches allowing the motor to operate even when the lid is in the open position so long as both override switches are held in the on position.

2. The apparatus according to claim 1 wherein the override switches are located on opposite sides of the apparatus.

3. The apparatus according to claim 1, wherein the lid is hinged to the tank.

4. The apparatus according to claim 1, wherein the sensor comprises a magnetic switch.

5. The apparatus according to claim 1, wherein the mixing member comprises an auger.

6. The apparatus according to claim 1, wherein the apparatus is portable and mounted on wheels.

7. The apparatus according to claim 1, wherein the pressure source comprises an electrically driven pump mounted between the outlet and the hose.

8. The apparatus according to claim 1, further comprising:
a water nozzle mounted to the tank, the water nozzle adapted to be connected to a source of water;
an electrical water control switch mounted to the apparatus for opening and closing the water nozzle, the water control requiring continuous manual pressure to be applied to enable the water nozzle to remain open; and
the water control switch being mounted to the apparatus within seven inches of one of the override switches to enable a user to maintain pressure on the water control switch while simultaneously maintaining pressure on said one of the override switches with the same hand.

9 An apparatus for dispensing wall compound, comprising;
a tank carried on a plurality of wheels, the tank having an open top for receiving wall compound and an outlet for dispensing the wall compound;
a lid mounted to the top of the tank for opening and closing the top;
a helical blade mounted to a shaft in the tank for mixing the compound and forcing the compound toward the outlet;
an electrically driven pump assembly mounted to the outlet;
a hose coupled to the pump assembly;
an applicator connector to the hose for applying the compound to a wall surface;
an electrical motor operatively connected with the shaft for rotating the blade;
a controller connected to the motor and to the pump assembly for controlling the motor and the pump assembly;
a sensor that detects when the lid is open;
the controller having a primary mixing switch that when closed, causes the motor to rotate the blade unless the sensor detects that the lid is open, in which case, the controller prevents the motor from rotating the blade; and
a pair of manually actuable override switches mounted on the apparatus for causing the motor to rotate the blade even though the lid is open when both of the override switches are simultaneously moved to an on position, the override switches both requiring continued manual pressure to remain in the on position, and the override switches being spaced apart from each other sufficiently to require at least two hands to simultaneously move them.

10. The apparatus according to claim 9, wherein the controller is contained in a housing mounted to the tank, and the override switches are located on oppositely facing sides of the controller.

11. The apparatus according to claim 9, wherein the override switches are located on opposite sides of the apparatus.

12. The apparatus according to claim 9, wherein the blade is helical.

13. The apparatus according to claim 9, further comprising:
a water nozzle mounted to the tank, the water nozzle adapted to be connected to a source of water;
an electrical water control switch mounted to the apparatus for opening and closing the water nozzle, the water control requiring continuous manual pressure to be applied to enable the water nozzle to remain open; and
the water control switch being mounted to the apparatus within seven inches of one of the override switches to enable a user to maintain pressure on the water control switch while simultaneously maintaining pressure on said one of the override switches with the same hand.

14. A method of applying a wallboard compound on a wall surface, comprising:
providing a tank with a lid on an upper end of the tank and a mixing member rotatably mounted within the tank, the member being driven by a motor that is controlled by a controller having a primary switch for supplying power to the motor to rotate the mixing member;
providing a pair of normally off manually actuable override switches which must both be continuously held in an on position to cause the controller to supply power to supply power to the motor, the override switches requiring physical force to be exerted against them to remain in the on position and being spaced apart from each other sufficiently to require both hands of a user to maintain them in the on position;
mounting a sensor to the tank that detects when the lid is open;
placing wallboard compound in the tank, closing the lid and placing the primary switch in an on position to cause the motor to rotate the mixing member;
signaling the controller with the sensor to stop operation of the motor if the lid is open while the primary switch is in the on position and at least one of the override switches is in the off position;
manually and continuously holding both of the override switches in the on position to cause the controller to supply power to the motor to rotate the mixing member while the lid is open to mix the compound while observing the compound; then,
closing the lid and continuing to mix the compound by rotating the mixing member while dispensing the compound out of the outlet and through a hose to an applicator, and applying the compound to a wall surface with the applicator.

15. The method according to claim 14, further comprising:
mounting a water nozzle to the tank and connecting the water nozzle adapted to be connected to a source of water;
mounting close to one of the override switches an electrical water control switch for opening and closing the water nozzle, the water control requiring continuous manual pressure to be applied to enable the water nozzle to remain open; and
manually holding the water control switch in an on position simultaneously with one of the override switches with one hand while holding the other of the override switches with the other hand to dispense water into the tank while the lid is up and the mixing member is rotating.
